(19) United States
(12) Patent Application Publication
(10) Pub. No.: US 2023/0295419 A1
(43) Pub. Date: Sep. 21, 2023

(54) TOY BUILDING ELEMENT MADE OF A POLYMERIC POLYESTER MATERIAL

(71) Applicant: LEGO A/S, Billund (DK)

(72) Inventors: Bistra ANDERSEN, Billund (DK); René MIKKELSEN, Billund (DK)

(21) Appl. No.: 18/010,147

(22) PCT Filed: Jun. 6, 2021
(86) PCT No.: PCT/EP2021/066247

§ 371 Date: Dec. 13, 2022

Related U.S. Application Data
(63) Continuation-in-part of application No. 16/767,201, filed on May 27, 2020.
Application No. 16/767,201 is a continuation-in-part of application No. 16/767,215, filed on May 27, 2020.

(30) Foreign Application Priority Data
Jun. 16, 2020 (EP) 20180141.2

(51) Int. Cl. C08L 67/02; A63H 33/08

(52) U.S. Cl. CPC C08L 67/02; A63H 33/086; B33Y 70/00

(57) ABSTRACT

The present disclosure relates to a toy building element made of a polyester material and manufactured by processing of a resin comprising at least one polyester, at least one reactive impact modifier and at least one non-reactive impact modifier. The present disclosure also relates to a method for the manufacture of such toy building element.

### CROSS REFERENCE TO RELATED APPLICATIONS

The present application is a U.S. National Stage Application of International Application No. PCT/EP2021/066247, filed on Jun. 16, 2021 and published on Dec. 23, 2021 as WO 2021/255098 A1, which claims the benefit and priority of European Patent Application No. 20180141.2, filed on Jun. 16, 2020, each of which is incorporated herein by reference in its entirety for any purpose whatsoever.

The present application is also a Continuation-in-Part of U.S. patent application Ser. No. 16/767,201, filed May 27, 2020 and published on Dec. 17, 2020 as U.S. Patent Publication No. 2020/0391133 A1, which is a U.S. National Stage Application of International Application No. PCT/EP2018/083082, filed on Nov. 30, 2018 and published on Jun. 6, 2019 as WO 2019/106124, which claims the benefit and priority to Danish Patent Application No. PA 201770900, filed on Dec. 1, 2017, each of which is incorporated herein by reference in its entirety for any purpose whatsoever.

The present application is also a Continuation-in-Part of U.S. patent application Ser. No. 16/767,215, filed May 27, 2020 and published on Jan. 7, 2021 as U.S. Patent Publication No. 2021/0001240 A1, which is a U.S. National Stage Application of International Application No. PCT/EP2018/083090, filed on Nov. 30, 2018 and published on Jun. 6, 2019 as WO 2019/106129, which claims the benefit and priority to Danish Patent Application No. PA 201770901, filed on Dec. 1, 2017, each of which is incorporated herein by reference in its entirety for any purpose whatsoever.

### FIELD OF THE DISCLOSURE

The present disclosure relates to a toy building element made of a polyester material and manufactured by processing of a resin comprising at least one polyester, at least one reactive impact modifier and at least one non-reactive impact modifier. The present disclosure also relates to a method for the manufacture of such toy building element.

### BACKGROUND

Polyesters are a category of polymers that contain an ester functional group in their main chain. They can be formed from the reaction of a diacid or acid anhydride and a diol with the elimination of water, or by ring-opening polymerization of cyclic (di-)esters. Polyesters are classified as aliphatic, semi-aromatic and aromatic according to the composition of their main chain. In general, aromatic acids and diols improve the hardness, rigidity and heat resistance, whereas aliphatic acids and diols increase the flexibility, lower the melting or softening point and improve the processability.

Common aliphatic diols are ethylene glycol, 1,4-butanediol and 1,3-propanediol. They are often reacted with aromatic diacids, such as terephthalic acid, phthalic acid, phthalic anhydride and naphthalene dicarboxylic acid. Glycerol and unsaturated acids (anhydrides) like maleic anhydride, are sometimes added to crosslink the polyester. In the case of unsaturated acids (anhydrides), crosslinking is achieved in a subsequent free radical chain polymerization. Double bonds in the backbone of the polyesters also improve the resistance to softening and deformation at elevated temperatures.

Poly(ethylene terephthalate), also referred to as PET, is a common thermoplastic polymer resin. It can be produced by reaction of ethylene glycol and terephthalic acid. Today PET is widely used to make containers for food, water and carbonated water and soft drinks and the like due to its excellent combination of mechanical and gas barrier properties. The transparent water bottles are manufactured by blow molding of amorphous PET. Hence, amorphous PET may be considered a low-cost raw material for the production of engineering compounds due to its widespread availability for example from recycled beverage bottles.

PET was not originally considered as an injection molding material because of high moisture sensitivity, poor impact strength and slow rate of crystallization, which slows the molding process.

The properties of PET can be modified and enhanced to such an extent that it can be used in industrial production of durable products. The slow crystallization rate can be improved by addition of nucleating agents and the poor impact strength can be improved by addition of glass, fibres, mineral or organic reinforcements, such as carbon nanotubes, graphene and graphite, and/or impact modifiers.

Standard bottle grade PET typically has an intrinsic viscosity in the range of 0.75 to 0.85 dl/g. Copolymer modification (acid or glycol modification) has been used to decrease the crystallization rate and to decrease the PET melting temperature, thereby decreasing the energy demand in the production process. Standard PET bottle polymers with copolymer modification typically have between 0% and 3 mol % isophthalic acid (IPA) modification in order to reduce the crystallization rate and allow the production of clear amorphous preforms weighing up to 100 grams.

Poly(ethylene furanoate), also referred to as PEF, is an aromatic thermoplastic polyester that can be easily molded and thermoformed. It can be produced by polycondensation of ethylene glycol and 2,5-furandicarboxylic acid (FDCA). PEF has many attractive properties including high tensile strength and high puncture toughness, good heat resistance, as well as outstanding gas barrier properties, which are superior to PET. PEF also has a lower melting point and a higher glass transition temperature than PET and thus more attractive thermal and mechanical properties. Information with regard to the impact strength is very sparse.

PEF is a known analogue to PET, which is capable of replacing PET because its chemical structure is very similar to the chemical structure of PET. In particular, the studies in recent years have been focused on the use of PEF for use as food and beverage packaging material, because of its better barrier properties, i.e. better ability to withstand gas (oxygen and carbon dioxide) permeability, as compared to PET.

It has been demonstrated that PEF can be recycled in very similar ways to PET recycling. Preliminary tests have shown that PEF has no material effect on the mechanical and physical properties of PET, such as strength and impact. It is therefore suggested that PEF is likely to be recycled in the PET recycling stream, at least in the transition period following the launch of PEF items on the market. It is considered that up to 2% PEF would be compatible in the existing PET recycling stream, and this upper limit of 2% PEF in the PET recycling stream has actually been granted by the European PET Bottle Platform.

Studies have not yet been focused on improving impact strength and toughness of PEF. However, because of its chemical similarity with PET it is credible that the impact strength of PEF may be improved in a similar way as for PET, when adding the same types and amounts of impact modifiers.

Poly(ethylene glycol-co-1,4-cyclohexanedimethanol terephthalate), also referred to as glycol modified polyethylene terephthalate or PETG, is prepared by partially replacing the ethylene glycol groups of PET with 1,4-cyclohexanedimethanol (CHDM) groups. In contrast to semicrystalline PET, glycol modified poly(ethylene terephthalate) copolyester is an amorphous thermoplastic that exhibits a glass transition temperature of about 80 degrees C., which is similar to the glass transition temperature of PET. In some studies, the glass transition temperature of PETG has been reported to be higher than for PET.

The impact strength of PETG depends on the content of ethylene glycol and 1,4-cyclohexanedimethanol terephthalate, respectively. The higher the content of 1,4-cyclohexanedimethanol terephthalate the higher impact strength.

Impact modifiers are known to improve the durability and toughness of polymer resins. Impact modifiers for PET are generally elastomeric compounds that increase impact strength and elongation while usually decreasing modulus. An effective way to enhance the impact strength is by the dispersion of a rubber phase within the PET matrix. The main role of the rubber particles is to induce an overall deformation mechanism rather than a localized phenomenon, thereby strongly increasing the amount of dissipated fracture energy. The effectiveness of rubber modification depends on the type of rubber, the rubber content, the rubber particle size and the interparticle distance.

Impact modifiers may be characterized as reactive or non-reactive. Reactive impact modifiers are preferred for toughening of PET since these form a stable dispersed phase by grafting to the PET matrix. Non-reactive elastomers can be dispersed into PET by intensive compounding but may coalesce downstream in the compounder.

Reactive impact modifiers have functionalized end groups. Functionalization serves two purposes: firstly to bond the impact modifier to the polymer matrix and secondly, to modify the interfacial energy between the polymer matrix and the impact modifier for enhanced dispersion.

Non-reactive (unfunctionalized) elastomeric impact modifiers are not highly effective at toughening polyesters because they are unable to adequately interact with the polyester matrix so as to achieve optimally sized dispersed phases and strong interfacial bonding. Non-reactive impact modifiers may take a unique core-shell structure. This structure is obtained by copolymerization of a hard shell around a soft rubber core and since the structure is typically obtained by emulsion copolymerization, it provides a well-defined particle size, which in turn leads to a well-controlled blend morphology. The soft rubber-core may be a butadiene core or an acrylic core, whereas the shell may be made of PMMA.

Polyesters are an interesting material for use in the manufacture of toys, such as toy building elements. However, impact strength needs to be modified in order to satisfy the requirements of product safety and play experience and so that long-lasting toy building bricks can be produced, which do not break when for example dropped on the floor or when stepped on by an adult person. The improved impact strength need to be focused on injection molded objects with complex geometries such as the geometry of a traditional LEGO® brick which has been on the market for many years when produced in conventional materials such as for example ABS.

### SUMMARY

The inventors of the present disclosure have developed a new polyester resin for use in the manufacture of toy building elements, which provides improved impact strength of the manufactured elements.

In particular, the inventors of the present disclosure have surprisingly found that markedly improved impact strength is obtained when a resin comprising one or more polyester(s), a reactive impact modifier and a non-reactive impact modifier is processed into toy building elements. In fact, a synergistic effect is observed when processing such polyester resins as compared to polyester resins comprising only the reactive impact modifier or the non-reactive impact modifier.

In a first aspect the present disclosure is directed to a toy building element made of a polyester material and manufactured by processing of a resin comprising at least one polyester, at least one reactive impact modifier and at least one non-reactive impact modifier, wherein the polyester is a poly(ethylene terephthalate) polyester (PET polyester) or a modified PET polyester, which has been modified by replacing
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; and/or
all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
   with the proviso that not all of the terephthalic acid groups and all of the ethylene glycol groups can be replaced at the same time.

In a second aspect the present disclosure is directed to a method for the manufacture of a toy building element comprising the steps of
a) providing a resin comprising at least one polyester, at least one reactive impact modifier and at least one non-reactive impact modifier, wherein the polyester is a poly(ethylene terephthalate) polyester (PET polyester) or a modified PET polyester, which has been modified by replacing
   all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof, and/or
   all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
with the proviso that not all of the terephthalic acid groups and all of the ethylene glycol groups can be replaced at the same time, and
b) processing said resin.

### BRIEF DESCRIPTION OF THE FIGURES

FIG. 1 shows a traditional box-shaped LEGO® 2*4 brick.

### DETAILED DESCRIPTION

The present disclosure is directed to a toy building element made of a polyester material and manufactured by processing of a resin comprising at least one polyester, at least one reactive impact modifier and at least one non-reactive impact modifier.

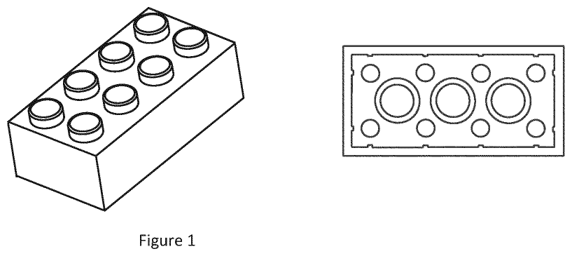

The term “toy building element” as used herein includes the traditional toy building elements in the form of box-shaped building bricks provided with knobs on the upper side and complementary tubes on the lower side. A traditional box-shaped toy building brick is shown in FIG. 1. The traditional box-shaped toy building bricks were disclosed for the first time in U.S. Pat. No. 3,005,282 and are widely sold under the tradenames LEGO® and LEGO® DUPLO®. The term also includes other similar box-shaped building bricks, which are produced by other companies than The LEGO Group and therefore sold under other trademarks than the trademark LEGO.

The term “toy building element” also includes other kinds of toy building elements that form part of a toy building set which typically comprises a plurality of building elements that are compatible with and hence can be interconnected with each other. Such toy building sets are also sold under the trademark LEGO, such as for example LEGO® bricks, LEGO® Technic and LEGO® DUPLO®. Some of these toy building sets includes toy building figures, such as for example LEGO® Minifigures (see for example US 05/877,800), having complementary tubes on the lower side so that the figure can be connected to other toy building elements in the toy building set. Such toy building figures are also encompassed by the term “toy building element”. The term also includes similar toy building elements, which are produced by other companies than The LEGO Group and therefore sold under other trademarks than the trademark LEGO.

The toy building elements are available in a large variety of shapes, sizes and colours. One difference between LEGO® bricks and LEGO® DUPLO® bricks is the size in that a LEGO® DUPLO® brick is twice the size of a LEGO® brick in all dimensions. The size of the traditional box-shaped LEGO® toy building brick having 4*2 knobs on the upper side is about 3.2 cm in length, about 1.6 cm in width and about 0.96 cm in height (excluding knobs), and the diameter of each knob is about 0.48 cm. In contrast, the size of a LEGO® DUPLO® brick having 4*2 knobs on the upper side is about 6.4 cm in length, about 3.2 cm in width and about 1.92 cm in height (excluding knobs), and the diameter of each knob is about 0.96 cm.

The toy building elements are manufactured either by injection molding or by additive manufacturing or by a combination of injection molding and additive manufacturing.

Injection molding of toy building elements is the traditional way of manufacturing toy building bricks. This manufacturing technique has been used for many years and is very well known to a skilled person. In some embodiments the toy building element is manufactured by injection molding of a polyester resin. In other embodiments the toy building element is manufactured by two-component injection molding, where one of the components is a polyester resin.

In recent years, the new additively manufacturing technique for building objects in for example polymeric material has been developed. By the term “additive manufacturing” or “additively manufactured” as used herein is meant that the brick is built in an additive fashion, i.e. by adding new material on top of either a substrate or on top of newly added material, by repeated solidification of a thin liquid layer or droplet on a substrate or on a previously solidified liquid layer or droplet, or by repeated printing with a thermoplastic polymeric material on a substrate or on a previously printed plastics material, or by repeated soldering in an additive fashion of plastics material e.g. by use of laser.

In some embodiments the toy building element is manufactured by injection molding. In other embodiments the toy building element is manufactured by additive manufacturing. In yet other embodiments the toy building element is manufactured by a combination of injection molding and additive manufacturing.

Such combined manufacturing technique is described for example in WO 2014/005591 where a toy building element with high degree of design individuality is manufactured by adding material in the layer-by-layer fashion on the surface of a traditional injection molded box-shaped building brick.

Hence, the toy building element is made of a polyester material and manufactured by processing of a resin comprising at least one polyester, at least one reactive impact modifier and at least one non-reactive impact modifier.

The term “polyester” as used herein includes both PET polyesters and modified PET polyesters and mixtures thereof. The modified PET polyester has been modified by replacing
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; and/or
all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
   with the proviso that not all of the terephthalic acid groups and all of the ethylene glycol groups can be replaced at the same time.

By the term “polyester resin” as used herein is meant a resin comprising at least one polyester as defined above, at least one reactive impact modifier and at least one non-reactive impact modifier.

The PET polyester is produced by polymerization of the monomers ethylene glycol and terephthalic acid. The modified PET polyester may be produced in three different ways. First of all, the modified PET polyester may be produced by polymerization of the monomers ethylene glycol, terephthalic acid and one or more further comonomer(s), which is/are a diacid monomer and/or a diol monomer thereby producing a diacid modification, a diol modification or a diacid/diol modification. Secondly, the modified PET polyester may be produced by polymerization of the monomer ethylene glycol and one or more further comonomer(s), which is/are one or more diacid monomer(s) and optionally one or more diol monomer(s). Thirdly, the modified PET polyester may be produced by polymerization of the monomer terephthalic acid and one or more further comonomer(s), which is/are one or more diol monomer(s) and optionally one or more diacid monomer(s). In all cases the diacid monomer is selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof and the diol monomer is selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof.

In some embodiments the resin comprises PET polyester. The PET polyester is produced by reaction of ethylene glycol and terephthalic acid. In a preferred embodiment the polyester is PET polyester.

In some embodiments the resin comprises a modified PET polyester, which has been produced by reaction of ethylene glycol and terephthalic acid and the comonomer 1,4-cyclohexanedimethanol. In other embodiments the resin comprises a modified PET polyester, which has been produced by reaction of ethylene glycol and terephthalic acid and the comonomer isophthalic acid. In other embodiments the resin comprises a modified PET polyester which has been produced by reaction of ethylene glycol and terephthalic acid and the comonomer 2,2,4,4-tetramehyl-1,3-cyclobutanediol. In other embodiments the resin comprises a modified PET polyester which has been produced by reaction of terephthalic acid and 1,4-cyclohexanedimethanol. In yet other embodiments the resin comprises a modified PET polyester, which has been produced by reaction of terephthalic acid, isophthalic acid and 1,4-cyclohexanedimethanol. In other embodiments the resin comprises a modified PET polyester, which has been produced by reaction of ethylene glycol, terephthalic acid, and 2,5-furandicarboxylic acid.

In preferred embodiments the resin comprises poly(ethylene terephthalate-co-isophthalate) polyester. The poly(ethylene terephthalate-co-isophthalate) polyester is produced by reaction of ethylene glycol, terephthalic acid and isophthalic acid.

In a preferred embodiment the polyester in the resin is a modified PET polyester, which is poly(ethylene terephthalate-co-isophthalate) polyesters. The amount of isophthalic acid in the poly(ethylene terephthalate-co-isophthalate) polyesters is typically 0.5-12 mol % and preferably 1-3 mol %.

The chemical composition of poly(ethylene terephthalate-co-isophthalate) polyesters, i.e. the amount of isophthalic acid in the poly(terephthalate-co-isophthalate) polyester, may be characterised by 13C Nuclear Magnetic Resonance spectroscopy (C NMR) according to the method described in “Martinez de Ilarduya, A.; Kint, D. P.; Muñoz-Guerra, S. Sequence Analysis of Poly (ethylene terephthalate-co-isophthalate) Copolymers by 13C NMR. Macromolecules 2000. 33, 4596-4598”. Accordingly, the amount of isophthalic acid may be measured using this C NMR method.

An important characteristic of PET is the intrinsic viscosity (IV). The intrinsic viscosity, which is measured in dl/g, is found by extrapolating the relative viscosity to zero concentration. It depends on the length of the PET polymer chains. The longer the polymer chains the more entanglements between chains and therefore the higher the viscosity. The average length of a particular batch of PET resin can be controlled during the polymerization process.

The PET Intrinsic Viscosity (IV) may be measured according to ASTM D4603.

High IV homo- and copolymer PET compositions are difficult to process in injection molding due to their high viscosity.

In some embodiments the IV of the PET polyester ranges from 0.6-1.1 dl/g, such as 0.7-0.9 dl/g, preferably from 0.75-0.85 dl/g.

In preferred embodiments the modified PET polyester is PET of bottle grade. The term “bottle grade” is well known in the technical area and refers to PET starting materials that can easily be processed into bottles. In most embodiments the “bottle grade” PET is made of poly(ethylene terephthalate-co-isophthalate) polyesters comprising 1-3 mol % of isophthalic acid. In bottle grade PET the IV is typically in the range of 0.70-0.78 dl/g for non-carbonated water, and in the range of 0.78-0.85 for carbonated water.

Suitable examples of PET grades which are also commercial available include bottle grade EASTLON PET CB-600, CB-602 and CB-608 supplied by Far Eastern New Century (FENC), commercial grade post-consumer rPET CB-602R supplied by FENC, partially bio-based bottle grade PET CB-602AB supplied by FENC and homopolymer PET grade 6020 supplied by Invista.

In some embodiments the resin comprises a modified PET polyester, which has been produced by reaction of ethylene glycol and terephthalic acid and the comonomer 1,4-cyclohexanedimethanol. In some embodiments the resin comprises poly(ethylene glycol-co-1,4-cyclohexanedimethanol terephthalate) polyesters, also referred to as glycol modified polyethylene terephthalate or PETG. In a preferred embodiment the polyester is a modified PET polyester, which is PETG. The amount of 1,4-cyclohexanedimethanol in the PETG is typically 0.1-25 mol %. In other embodiments the resin comprises ethylene glycol modified poly(cyclohexylenedimethylene terephthalate) also referred to as PCTG.

In a preferred embodiment the polyester is a modified PET polyester, which is PETG. The amount of 1,4-cyclohexanedimethanol in the PETG is typically 25-49.99 mol %.

In other embodiments the resin comprises a modified PET polyester which has been produced by reaction of ethylene glycol and terephthalic acid and the comonomer 2,2,4,4-tetramehyl-1,3-cyclobutanediol. In some embodiments the resin comprises poly(ethylene glycol-co-2,2,4,4-tetramethyl-1,3-cyclobutanediol terephthalate) also referred to as PETT.

In other embodiments the resin comprises a modified PET polyester which has been produced by reaction of terephthalic acid and 1,4-cyclohexanedimethanol. In some embodiments the resin comprises poly(cyclohexanedimethylene terephthalate) also referred to as PCT.

In yet other embodiments the resin comprises a modified PET polyester, which has been produced by reaction of terephthalic acid, isophthalic acid and 1,4-cyclohexanedimethanol. In some embodiments the resin comprises isophthalic acid modified poly(cyclohexanedimethylene terephthalate) also referred to as PCTA. The amount of isophthalic acid is typically 0.1-50 mol %, more typically 0.1-5 mol %.

In some embodiments the resin comprises poly(ethylene furanoate-co-ethylene terephthalate) polyester. The poly(ethylene furanoate-co-ethylene terephthalate) polyester is produced by reaction of ethylene glycol, terephthalic acid and 2,5-furandicarboxylic acid. The amount of 2,5-furandicarboxylic acid in the modified PET polyester is typically 0.5-12 mol % and preferably 1-3 mol %.

In some embodiments the resin comprises poly(ethylene furanoate) polyester, also referred to as PEF. The poly(ethylene furanoate) polyester is produced by reaction of ethylene glycol and furandicarboxylic acid. In a preferred embodiment the polyester is a modified PET polyester, which is PEF.

In other embodiments the resin comprises a mixture of poly(ethylene terephthalate) polyester and poly(ethylene furanoate) polyester. In other embodiments the resin comprises a mixture of poly(ethylene terephthalate-co-isophthalate) polyester and poly(ethylene furanoate) polyester. In yet other embodiments the resin comprises a mixture of poly(ethylene terephthalate) polyester, poly(ethylene terephthalate-co-isophthalate) polyester and poly(ethylene furanoate) polyester. In any of these mixtures the amount of poly(ethylene furanoate) polyester is typically 0.1-10% (wt/wt), such as for example 0.1-5% (wt/wt) or 0.1-2% (wt/wt) based on total amount of polyesters.

In some embodiments the polyester resin is an unfilled polyester resin.

By the term “unfilled polyester resin” as used herein is meant a polyester resin which does not comprise reinforcing and filling material, such as glass, glass beads, fibres, mineral reinforcements, such as aluminum silicate, talc, asbestos, mica and calcium carbonate, and organic reinforcements, such as aramid fibres, carbon nanotubes, graphene and graphite.

In one embodiment the polyester resin does not contain glass, glass beads and/or glass fibres. In one embodiment the polyester resin does not contain fibres. In one embodiment the polyester resin does not contain inorganic reinforcements, such as aluminum silicate, asbestos, talc, mica and calcium carbonate. In one embodiment the polyester resin does not contain organic reinforcements, such as aramid fibres, carbon nanotubes, graphene and graphite. In one embodiment the polyester resin does not contain glass and fibres.

In another preferred embodiment the polyester resin further comprises one or more filler(s) in an amount of up to 5% (wt/wt) relative to the total weight of the resin, such as from 0.1-5% (wt/wt), more preferred from 0.2-4% (wt/wt), most preferred from 0.5-3% (wt/wt). The one or more filler(s) may be inorganic particulate material or a nanocomposite or a mixture thereof.

Suitable examples of inorganic particulate material include inorganic oxides, such as glass, MgO, SiO2, TiO2 and Sb2O3; hydroxides, such as Al(OH)3 and Mg(OH)2; salts, such as CaCO3, BaSO4, CaSO4 and phosphates; silicates, such as talc, mica, kaolin, wollastonite, montmorillonite, nanoclay, feldspar and asbestos; metals, such as boron and steel; carbon-graphite, such as carbon fibers, graphite fibers and flakes, carbon nanotubes and carbon black. Suitable examples of inorganic particulate material also include surface treated and/or surface modified SiO2 and TiO2, such as for example alumina surface modified TiO2.

Suitable examples of nanocomposites include clay filled polymers, such as clay/low density polyethylene (LDPE) nanocomposites, clay/high density polyethylene (HDPE) nanocomposites, acrylonitrile-butadiene-styrene (ABS)/clay nanocomposites, polyimide (PI)/clay nanocomposites, epoxy/clay nanocomposites, polypropylene (PP)/clay nanocomposites, poly (methyl methacrylate) (PMMA)/clay nanocomposites and polyvinyl chloride (PVC)/clay nanocomposites; alumina filled polymers, such as epoxy/alumina nanocomposites, PMMA/alumina nanocomposites, Pl/alumina nanocomposites, PP/alumina nanocomposites, LDPE/alumina nanocomposites and cross-linked polyethylene (XLPE)/alumina nanocomposites; barium titanate filled polymers, such as HDPE/barium titanate nanocomposites and polyetherimide (PED/barium titanate nanocomposites; silica filled polymers, such as PP/silica nanocomposites, epoxy/silica nanocomposites, PVC/silica nanocomposites, PEI/silica nanocomposites, PI/silica nanocomposites, ABS/silica nanocomposites, and PMMA/silica nanocomposites; and zinc oxide filled polymers, such as LDPE/zinc oxide nanocomposites, PP/zinc oxide nanocomposites, epoxy/zinc oxide nanocomposites and PMMA/zinc oxide nanocomposites.

In one embodiment the resin comprises polyester in an amount of at least 50% (wt/wt) relative to the total weight of the resin. In other embodiments the resin comprises polyester in an amount of at least 60% or 70% or 80% (wt/wt) relative to the total weight of the resin. In preferred embodiments the resin comprises polyester in an amount of at least 85%, such as at least 90% (wt/wt) relative to the total weight of the resin, more preferred at least 95% or 97% or 99% (wt/wt) relative to the total weight of the resin.

In another embodiment the resin comprises polyester in an amount of 50-99.5% (wt'wt) relative to the total weight of the resin. In other embodiments the resin comprises polyester in an amount of 60-97% or 70-95% (wt/wt) relative to the total weight of the resin. In a preferred embodiment the resin comprises polyester in an amount of 75-95%, more preferred 77-92%, even more preferred 80-90% (wt/wt) relative to the total weight of the resin.

The polyester in the resin may be a bio-based polymer, a hybrid bio-based polymer or a petroleum-based polymer, or a mixture thereof.

By the term “bio-based polymer” as used herein is meant a polymer, which is produced by chemical, or biochemical polymerization of monomers derived from biomass. Bio-based polymers include polymers produced by polymerization of one type of monomer derived from biomass as well as polymers produced by polymerization of at least two different monomers derived from biomass.

In a preferred embodiment the bio-based polymer is produced by chemical or biochemical polymerization of monomers, which are all derived from biomass.

Bio-based polymers according to the present disclosure include
Polymers produced by biochemical polymerization, i.e. for example by use of microorganisms. The monomers are produced using biomass as substrate.
Polymers produced by chemical polymerization, i.e. by chemical synthesis. The monomers are produced using biomass as substrate.

In some embodiments, the bio-based polymer is produced by biochemical polymerization. In other embodiments the bio-based polymer is produced by chemical polymerization. In yet other embodiments the bio-based polymers are produced by biochemical or chemical polymerization. The bio-based polymer may also be produced by a combination of biochemical and chemical polymerization, for example in cases where two monomers are combined to a dimer by a biochemical reaction path and then the dimers are polymerized by use of chemical reaction.

Bio-based polymers also include polymers having the same molecular structure as petroleum-based polymers, but which have been produced by chemical and/or biochemical polymerization of monomers derived from biomass.

By the term “petroleum-based polymers” as used herein is meant a polymer produced by chemical polymerization of monomers derived from petroleum, petroleum by-products or petroleum-derived feedstocks.

By the term “hybrid bio-based polymer” as used herein is meant a polymer, which is produced by polymerization of at least two different monomers, where at least one monomer is derived from biomass and at least one monomer is derived from petroleum, petroleum by-products or petroleum-derived feedstocks. The polymerization process is typically a chemical polymerization process.

The hybrid bio-based polymers may also be characterized by their content of bio-based carbon per total carbon content. The term “bio-based carbon” as used herein refers to the carbon atoms that originate from the biomass that is used as substrate in the production of monomers, which form part of the bio-based polymers and/or the hybrid bio-based polymers. The content of bio-based carbon in the hybrid bio-based polymer can be determined by Carbon-14 isotope content as specified in ASTM D6866 or CEN/TS 16137 or an equivalent protocol.

In some embodiments the content of bio-based carbon in the hybrid bio-based polymer is at least 25% based on the total carbon content of the hybrid bio-based polymer, such as for example at least 30% or at least 40%. In other embodiments the content of bio-based carbon in the hybrid bio-based polymer is at least 50% based on the total carbon content, such as at least 60% for example at least 70%, such as at least 80% based on the total carbon content of the hybrid bio-based polymer.

In one embodiment the ethylene glycol monomers and/or the diol monomers are bio-based monomers whereas the terephthalic acid monomers and/or the diacid monomers are not bio-based monomers, such as for example petroleum-based monomers. In another embodiment the terephthalic acid monomers and/or the diacid monomers are bio-based monomers whereas the ethylene glycol monomers and/or the diol monomers are not bio-based monomers. In yet another embodiment the ethylene glycol monomers and/or the dial monomers and the terephthalic acid monomers and/or the diacid monomers are bio-based monomers. In even yet another embodiment neither the ethylene glycol monomers nor the diol monomers nor the terephthalic acid monomers nor the diacid monomers are bio-based monomers.

In one preferred embodiment the ethylene glycol monomers and/or the diol monomers are bio-based monomers derived from biomass and having a content of bio-based carbon equal to 100% based on the total carbon content in the ethylene glycol monomers and/or diol monomers. In other embodiments the ethylene glycol monomers and/or diol monomers have a content of bio-based carbon of at least 25% based on the total carbon content in the ethylene glycol monomers and/or diol monomers, such as for example at least 50%, preferably at least 70%, more preferred at least 90% and most preferred at least 95%.

In one preferred embodiment the terephthalic acid monomers and/or diacid monomers are bio-based monomers derived from biomass and having a content of bio-based carbon equal to 100% based on the total carbon content in the terephthalic acid monomers and/or diacid monomers. In other embodiments the terephthalic acid monomers and/or diacid monomers have a content of bio-based carbon of at least 25% based on the total carbon content in the terephthalic acid monomers and/or diacid monomers, such as for example at least 50%, preferably at least 70%, more preferred at least 90% and most preferred at least 95%.

In some embodiments the content of bio-based carbon in the polyester is at least 25% based on the total carbon content in the polyester. In other embodiments the content of bio-based carbon in the polyester is at least 50% based on the total carbon content, such as at least 60% for example at least 70%, preferably at least 80%, more preferably at least 90%, even more preferably at least 95%. In the most preferred embodiment the content of bio-based carbon in the polyester is 100% based on the total carbon content in the polyester.

In some embodiments the content of bio-based carbon in the resin is at least 25% based on the total carbon content in the resin. In other embodiments the content of bio-based carbon in the resin is at least 50% based on the total carbon content in the resin, such as at least 60% for example at least 70%, preferably at least 75%, more preferably at least 80%, even more preferably at least 85%. In the most preferred embodiment the content of bio-based carbon in the resin is 90% based on the total carbon content in the resin.

The terms “bio-based polymer”, “hybrid bio-based polymer” and “petroleum-based polymer” also include recycled polymers and recycled material comprising “bio-based polymer”, “hybrid bio-based polymer” and “petroleum-based polymer”.

The term “recycled material” as used herein refers to a material, which is obtained by processing of a resin comprising recycled polymers. The recycled polymers are obtained from waste materials. The waste material can be mechanically recycled material or chemically recycled material.

“Mechanically recycled material” refers to material which has been recovered by mechanically recycling of material. Mechanical recycling involves only mechanical processes, such as for example grinding, washing, separating, drying, re-granulating and compounding. In a typical recycling process, the waste material is collected and washed in order to remove contaminants. The cleaned plastic is then grinded into flakes, which can be compounded and pelletized or reprocessed into granulate.

“Chemically recycled material” includes materials which has been obtained by pyrolysis, chemical depolymerisation, solvent dissolution or any other suitable chemical recycling process.

“Pyrolysis” refers to breakdown of the material to crude oil at elevated temperature in the absence of oxygen. New virgin-like polymers can then be made from the resulting oil by known polymerization processes.

“Chemical depolymerisation” refers to the process of breaking down of a polymer into either monomers, mixtures of monomers or intermediates thereof using a chemical agent. New virgin-like polymers can be produced by polymerization of the monomers.

“Solvent dissolution” refers to the selective extraction of polymers using solvents. The extracted polymers are recovered by precipitation of the polymer or by evaporation of the solvent. The polymer chain and structure is not broken down.

The term “recycled polymer” refers to the polymer comprised in the mechanically recycled waste material or the polymer, which is chemically recovered from the waste material in the solvent dissolution process. The term also refers to the virgin-like polymer, which is produced in the pyrolysis recycling process or the chemical depolymerisation recycling process. When the term refers to virgin-like polymers then it also includes polymers where only one or two of the monomers have been recycled by pyrolysis or chemical depolymerisation.

In some embodiments the resin comprises mechanically recycled polyesters. In other embodiments the resin comprises mechanically recycled polyesters and bio-based polyesters. In other embodiments the resin comprises mechanically recycled polyesters and hybrid bio-based polyesters. In yet other embodiments the resin comprises mechanically recycled polyesters and petroleum-based polyesters. In still other embodiments the resin comprises mechanically recycled polyesters, bio-based polyesters and petroleum-based polyesters. In still other embodiments the resin comprises mechanically recycled polyesters, hybrid bio-based polyesters and petroleum-based polyesters. In yet other embodiments the resin comprises mechanically recycled polyesters, bio-based polyesters and hybrid bio-based polyesters. And in other embodiments the resin comprises mechanically recycled polyesters, bio-based polyesters, hybrid bio-based polyesters and petroleum-based polyesters.

In some embodiments, the amount of mechanically recycled polyester in the resin is at least 10% (wt/wt) based on the total weight of the resin, such as at least 20%, or for example at least 30%, such as at least 40% or for example at least 50%. In other embodiments, the amount of mechanically recycled polyester in the resin is at least 60% (wt/wt) based on the total weight of the resin, such as at least 70%, or for example at least 75%, such as at least 80% or for example at least 85%.

In some embodiments the polyester comprises chemically recycled monomers. In other embodiments the polyester comprises chemically recycled monomers and bio-based monomers. In other embodiments the polyester comprises chemically recycled monomers and hybrid bio-based monomers. In yet other embodiments the polyester comprises chemically recycled monomers and petroleum-based monomers. In still other embodiments the polyester comprises chemically recycled monomers, bio-based monomers and petroleum-based monomers. In still other embodiments the polyester comprises chemically recycled monomers, hybrid bio-based monomers and petroleum-based monomers. In yet other embodiments the polyester comprises chemically recycled monomers, bio-based monomers and hybrid bio-based monomers. And in other embodiments the polyester comprises chemically recycled monomers, bio-based monomers, hybrid bio-based monomers and petroleum-based monomers.

In some embodiments, the amount of chemically recycled monomers in the polyester is at least 10% (wt/wt) based on the total weight of the polyester, such as at least 20%, or for example at least 30%, such as at least 40% or for example at least 50%. In other embodiments, the amount of chemically recycled monomers in the polyester is at least 60% (wt/wt) based on the total weight of the polyester, such as at least 70%, or for example at least 80%, such as at least 90% or for example at least 95%.

In some embodiments the resin comprises a mixture of recycled poly(ethylene terephthalate) polyester and recycled poly(ethylene furanoate) polyester. In other embodiments the resin comprises a mixture of recycled poly(ethylene terephthalate-co-isophthalate) polyester and recycled poly(ethylene furanoate) polyester. In yet other embodiments the resin comprises a mixture of recycled poly(ethylene terephthalate) polyester, recycled poly(ethylene terephthalate-co-isophthalate) polyester and recycled poly(ethylene furanoate) polyester.

The polyester resin comprises at least one reactive impact modifier and at least one non-reactive impact modifier.

By the term “impact modifier” as used herein is meant an agent that increases the impact strength of the produced toy building element. The impact strength is measured using the Charpy v-notch test as defined below.

By the term “reactive impact modifier” as used herein is meant an impact modifier having functionalized end groups. These functionalized end groups serve two purposes: 1) to bond the impact modifier to the polymer matrix and 2) to modify the interfacial energy between the polymer matrix and the impact modifier for enhanced dispersion. Preferred examples of such functionalized end groups include glycidyl methacrylates, maleic anhydrides and carboxylic acids.

In a preferred embodiment the reactive impact modifier is a copolymer of the formula X/Y/Z where X is aliphatic or aromatic hydrocarbon polymer having 2-8 carbon atoms, Y is a moiety comprising an acrylate or methacrylate having 3-6 and 4-8 carbon atoms, respectively, and Z is a moiety comprising methacrylic acid, glycidyl methacrylate, maleic anhydride or carboxylic acid.

In one preferred embodiment the reactive impact modifier may be described by the formula:

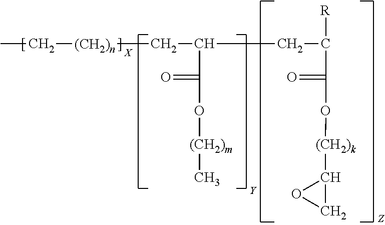

where
n is an integer from 1 to 4,
m is an integer from 0 to 5,
k is an integer from 0 to 5, and
R is an alkyl of 1 to 5 carbon or 1 hydrogen atom.

X constitutes 40-90% (wt/wt) of the impact modifier, and Y constitutes 0-50% (wt/wt), such as 10-40% (wt/wt), preferably 15-35% (wt/wt), most preferably 20-35% (wt/wt) of the impact modifier, and Z constitutes 0.5-20% (wt/wt), preferably 2-10% (wt/wt), most preferably 3-8% (wt/wt) of the reactive impact modifier.

10

In other embodiments, X constitutes 70-99.5% (wt/wt) of the reactive impact modifier, preferably 80-95% (wt/wt), most preferably 92-97% (wt/wt) and Y constitutes 0% (wt/wt) of the impact modifier, and Z constitutes 0.5-30% (wt/wt), preferably 5-20% (wt/wt), most preferably 3-8% (wt/wt) of the reactive impact modifier.

Suitable examples of specific reactive impact modifiers that can be used in the resin of the present disclosure include ethylene-ethylene acrylate-glycidyl methacrylate and ethylene-butyl acrylate-glycidyl methacrylate. Commercial available impact modifiers include Paraloid™ EXM-2314 (an acrylic copolymer from Dow Chemical Company), Lotader® AX8700, Lotader® AX8900, Lotader AX8750®, Lotader® AX8950 and Lotader® AX8840 (manufactured by Arkema) and Elvaloy® PTW (manufactured by DuPont).

Other suitable examples of specific reactive impact modifiers that can be used in the resin of the present disclosure include anhydride modified ethylene acrylates. Commercial available impact modifiers include Lotader® 3210, Lotader® 3410, Lotader® 4210, Lotader® 3430, Lotader® 4402, Lotader® 4503, Lotader® 4613, Lotader® 4700, Lotader® 5500, Lotader® 6200, Lotader® 8200, Lotader® FIX8210, Lotader® HX8290, Lotader® LX4110, Lotader® TX8030 (manufactured by Arkema), Bynel® 21E533, Bynel® 21E781, Bynel® 21E810 and Bynel® 21E830 (manufactured by DuPont).

In other embodiments the reactive impact modifier is a modified ethylene vinyl acetate, such as for example Bynel® 1123 or Bynel® 1124 (manufactured by DuPont), an acid modified ethylene acrylate, such as for example Bynel® 2002 or Bynel® 2022 (manufactured by DuPont), a modified ethylene acrylate, such as for example Bynel® 22E757, Bynel® 22E780 or Bynel® 22E804 (manufactured by DuPont), an anhydride modified ethylene vinyl acetate, such as for example Bynel® 30E670, Bynel® 30E671, Bynel® 30E753 or Bynel® 30E783 (manufactured by DuPont), and acid/acrylate modified ethylene vinyl acetate, such as for example Bynel® 3101 or Bynel® 3126 (manufactured by DuPont), an anhydride modified ethylene vinyl acetate, such as for example Bynel® E418, Bynel® 3810, Bynel® 3859, Bynel® 3860 or Bynel® 3861 (manufactured by DuPont), an anhydride modified ethylene vinyl acetate, such as for example Bynel® 3930 or Bynel® 39E660 (manufactured by DuPont), and anhydride modified high density polyethylene, such as for example Bynel® 4033 or Bynel® 40E529 (manufactured by DuPont), an anhydride modified linear low density polyethylene, such as for example Bynel® 4104, Bynel® 4105, Bynel® 4109, Bynel® 4125, Bynel® 4140, Bynel® 4157, Bynel® 4164, Bynel® 41E556, Bynel® 41E687, Bynel® 41E710, Bynel® 41E754, Bynel® 41E755, Bynel® 41E762, Bynel® 41E766, Bynel® 41E850, Bynel® 41E865 or Bynel® 41E871 (manufactured by DuPont) an anhydride modified low density polyethylene, such as for example Bynel® 4206, Bynel® 4208, Bynel® 4288 or Bynel® 42E703 (manufactured by DuPont) or an anhydride modified polypropylene, such as for example Bynel® 50E571, Bynel® 50E662, Bynel® 50E725, Bynel® 50E739, Bynel® 50E803 or Bynel® 50E806 (manufactured by DuPont).

Other suitable reactive impact modifiers include maleic anhydride grafted impact modifiers. Specific examples of such reactive impact modifiers include chemically modified ethylene acrylate copolymers, such as Fusabond® A560 (manufactured by DuPont), an anhydride modified polyethylene, such as Fusabond® E158 (manufactured by DuPont), an anhydride modified polyethylene resin, such as for example Fusabond® E564 or Fusabond® E589 or Fusabond® E226 or Fusabond® E528 (manufactured by DuPont), an anhydride modified high density polyethylene, such as for example Fusabond® E100 or Fusabond® E265 (manufactured by DuPont), an anhydride modified ethylene copolymer, such as for example Fusabond® N525 (manufactured by DuPont), or a chemically modified propylene copolymer, such as for example Fusabond® E353 (manufactured by DuPont).

Yet other suitable reactive impact modifiers include ethylene-acid copolymer resins, such as ethylene-methacrylic acid (EMAA) based copolymers and ethylene-acrylic acid (EAA) based copolymers. Specific examples of ethylene-methacrylic acid based copolymer impact modifiers include Nucrel® 403, Nucrel® 4071HS, Nucrel® 411HS, Nucrel® 0609HSA, Nucrel® 0903, Nucrel® 0903HC, Nucrel® 908HS, Nucrel® 910, Nucrel® 910HS, Nucrel® 1202HC, Nucrel® 599, Nucrel® 699, Nucrel® 925 and Nucrel® 960 (manufactured by DuPont). Specific examples of ethylene-acrylic acid based copolymers Nucrel® 30707, Nucrel® 30907, Nucrel® 31001, Nucrel® 3990 and Nucrel® AE (manufactured by DuPont). Other specific examples of ethylene of ethylene-acrylic acid (EAA) based copolymers include Escort™ 5000, Escort™ 5020, Escor™ 5050, Escor™ 5080, Escor™ 5100, Escor™ 5200 and Escor™ 6000 (manufactured by ExonMobile Chemical).

Still other suitable reactive impact modifiers include ionomers of ethylene acid copolymers. Specific examples of such impact modifiers include Surlyn® 1601, Surlyn® 1601-2, Surlyn® 1601-2LM, Surlyn® 1605, Surlyn® 8150, Surlyn® 8320, Surlyn® 8528 and Surlyn® 8660 (manufactured by DuPont).

In other embodiments the reactive impact modifier is an alkyl methacrylate-silicone/alkyl acrylate graft copolymer. The “alkyl methacrylate” of the graft copolymer may be one selected from the group consisting of methyl methacrylate, ethyl methacrylate, propyl methacrylate, isopropyl methacrylate and butyl methacrylate. The “silicone/alkyl acrylate” in the graft copolymer refers to a polymer obtained by polymerizing a mixture of a silicone monomer and an alkyl acrylate monomer. The silicone monomer may be selected from the group consisting of dimethylsiloxane, hexamethylcyclotrisiloxane, octamethylcyclo-tetrasiloxane, decamethylcyclopentasiloxane, dodecamethylcyclohexasiloxane, trimethyltriphenylcyclotetrasiloxane, tetramethyltetraphenylcyclotetrasiloxane and octaphenylcyclotetrasiloxane. The alkyl monomer may be selected from the group consisting of methyl methacrylate, ethyl methacrylate, propyl methacrylate, isopropyl methacrylate, butyl methacrylate and butyl methacrylate. The graft copolymer is in the form of core-shell rubber and has a graft rate of 5 to 90% (wt/wt), a glass transition temperature of the core of −150 to −20 degrees C., and a glass transition temperature of the shell of 20 to 200 degrees C. In one embodiment of the present disclosure, the graft copolymer is methyl methacrylate-silicone/butyl acrylate graft copolymer. Specific examples include S-2001, S-2100, S-2200 and S-2501 manufactured by Mitsubishi Rayon Co., Ltd. In Japan.

Other suitable reactive impact modifiers include the siloxane polymers mentioned in U.S. Pat. No. 4,616,064, which contain siloxane units, and at least one of carbonate, urethane or amide units.

Suitable reactive and non-reactive impact modifiers also include those mentioned in WO 2018/089573 paragraphs [0043]-[0072].

By the term “non-reactive impact modifier” as used herein is meant an impact modifier, which does not have functionalized end groups and therefore cannot form covalent chemical bonds with the polymer matrix. The non-reactive impact modifiers are typically dispersed into the polymer matrix by intensive compounding but may coalesce downstream in the compounder.

Non-reactive impact modifiers may take a unique core-shell structure. This structure is obtained by copolymerization of a hard shell around a soft rubber core and since the structure is typically obtained by emulsion copolymerization, it provides a well-defined particle size, which in turn leads to a well-controlled blend morphology.

Suitable examples of non-reactive core-shell impact modifiers include those mentioned in U.S. Pat. No. 5,409,967, i.e. core-shell impact modifiers with a core comprised mainly of a rubbery core polymer such as a copolymer containing a diolefin, preferably a 1,3-diene, and a shell polymer comprised mainly of a vinyl aromatic monomer, such as styrene, and hydroxylalkyl (meth)acrylate or, in the alternative, another functional monomer which acts in a manner similar to the hydroxylalkyl (meth)acrylate. Other suitable examples include impact modifiers with a soft rubber-core, such as for example a butadiene core, an acrylic core or a silicone-acrylic core, and a shell made of polymethyl (methacrylate) (PMMA).

In some embodiments the reactive impact modifier has a functionalized end group, which is selected from the group consisting of glycidyl methacrylate, maleic anhydride and carboxylic acid. In a preferred embodiment the functionalized group of the reactive impact modifier is glycidyl methacrylate.

In some embodiments the reactive impact modifier has a functionalized end group, which is selected from the group consisting of glycidyl methacrylate, maleic anhydride and carboxylic acid, and the non-reactive impact modifier is a core shell impact modifier. In a preferred embodiment the reactive impact modifier has a functionalized end group, which is glycidyl methacrylate, and the non-reactive impact modifier is a core shell impact modifier.

In some embodiments the non-reactive impact modifier is a core shell impact modifier. In a preferred embodiment the non-reactive impact modifier is a core shell impact modifier with a butadiene core, an acrylic core or a silicone-acrylic core, and a shell made of polymethyl (methacrylate) (PMMA).

In some embodiments the reactive impact modifier has a functionalized end group, which is selected from the group consisting of glycidyl methacrylate, maleic anhydride and carboxylic acid, and the non-reactive impact modifier is an ethylene-acrylate co-polymer. In a preferred embodiment the reactive impact modifier has a functionalized end group, which is glycidyl methacrylate, and the non-reactive impact modifier is an ethylene-acrylate co-polymer.

In some embodiments the amount of reactive impact modifier in the polyester resin is 0.25-10% (wt/wt) based on the total weight of the resin. In preferred embodiments the amount of reactive impact modifier in the polyester resin is 0.5-5% (wt/wt) based on the total weight of the resin, such as 1-3% (wt/wt) based on the total weight of the resin.

In some embodiments the amount of non-reactive impact modifier in the polyester resin is 0.25-15% (wt/wt) based on the total weight of the resin. In preferred embodiments the amount of non-reactive impact modifier in the polyester resin is 0.5-10% (wt/wt) based on the total weight of the resin, such as 1-3% (wt/wt) based on the total weight of the resin.

In some embodiments the total amount of impact modifier in the polyester resin is 0.5-25% (wt/wt) based on the total weight of the resin. In some embodiments the total amount of impact modifiers is 2-15% (wt/wt), such as 2-5% (wt/wt) or 5-8% (wt/wt) or 8-12% (wt/wt) based on the total weight of the resin.

The resin may in addition to fillers and impact modifiers further comprise lubricants. Lubricants are typically added to the resin in order to improve the processability and demolding performance of the resin and prevent damage to the injection molding equipment by reducing friction (external lubricants) and by reducing viscosity and heat dissipation (internal lubricants). External lubricants migrate to the interface between the molten resin and the surface of the processing equipment and reduce friction during processing, reduce the resin's adhesion to the surface of the mold and prevent melt fracture. In addition, external lubricants reduce the coefficient of friction and often improve the scratch resistance of the molded parts. Internal lubricants promote the flow of the resin and facilitate mold filing.

Suitable lubricants that can be used in the resins of the present disclosure include fatty alcohols with chain length from C12 to C22 produced either by hydrogenation of fatty acids or from ethylene via Ziegler process. These fatty alcohols may also be subjected to esterification with dicarboxylic acids. These lubricants are effective internal lubricants. Suitable lubricants include those sold under trade names Abrilube and Abriflo (manufactured by Abril Industrial Waxes), Interlite (manufactured by Akros Chemical), Baerolub (manufactured by Baerlocher GmBH), Naftolub (manufactured by Chemson Polymer-Additive Ges.mbH), Loxiol (manufactured by Cognis Deutchland GmbH), Ligalub (manufactured by Peter Greven Fettchemie), Atmer (manufactured by Uniqema) and Marklube (manufactured by Witco Vinyl Additives GmbH).

Other suitable lubricants include fatty acid esters of short-chain alcohols, such as for example esters of fatty acid glycerides. Suitable examples include liquid glycerol monoleate and solid glycerol monostearate and triglyceride esters of 12-hydroxystearic acid (hydrogenated castor oil). Other suitable examples include the stearic acid esters of trimethylol propane and pentaerythritol, and N-butyl stearate and isobutyl stearate. These are known to act as internal lubricants. Suitable lubricants include those sold under trade names Interlite (manufactured by Akros Chemical), Baerolub (manufactured by Baerlocher GmBH), Naftolub (manufactured by Chemson Polymer-Additive Ges.mbH), Loxiol (manufactured by Cognis Deutchland GmbH), Lubriol (manufactured by Comiel (Morton International Group)), Syncrolube (manufactured by Croda Oleochemicals), Petrac waxes (manufactured by Ferro Corporation), Tegomer 9xx (manufactured by Th. Goldschmidt AG), Glycolub, Glycostat and Polyaldo (manufactured by Lonza Benelux B.V.), Radia and Radiasurf (manufactured by Fina Chemicals N.V.), Ligalub (manufactured by Peter Greven Fettchemie), Realub (manufactured by Reagens Societa per Azioni Industria), Waxso (manufactured by SO.G.J.S. Industria Chimica S. p. a.), Atmer and Estol (manufactured by Uniqema) and Marklube (manufactured by Witco Vinyl Additives GmbH).

Fatty acids, such as stearic acid, can also act as suitable lubricants in the resins of the present disclosure. These are known to have good release effect. Suitable lubricants include those sold under trade names Interlite (manufactured by Akros Chemical), Baerolub (manufactured by Baerlocher GmBH), Naftozin (manufactured by Chetnson Polymer-Additive Ges.mbH), Loxiol (manufactured by Cognis Deutchland GmbH), Lubriol (manufactured by Comiel (Morton International Group)), Crodacid (manufactured by Croda Oleochemicals), Stavinor (manufactured by Ceca), Petrac waxes (manufactured by Ferro Carporation), Radiacid (manufactured by Fina Chemicals N.V.), Ligalub (manufactured by Peter Greven Fettchemie), Waxso (manufactured by SO.G.J.S. Industria Chimica S. p. a.), and Prifrac and Pristerene (manufactured by Uniqema).

Fatty acid amides are yet another example of suitable lubricants to be used in the resins of the present disclosure. Examples include oleic acid amide and erucamide as well as bis(stearyol)ethylenediamine, generally known as amide wax. These lubricants show a distinct slip effect. Suitable lubricants include those sold under trade names Abrilube and Abriflo (manufactured by Abril Industrial Waxes), Armoslip (manufactured by Akzo Nobel Chemicals), Licowax (manufactured by Clariant GmbH), Loxamid (manufactured by Cognis Deutch land GmbH), Lubriol (manufactured by Comiel (Morton International Group)), Crodamid (manufactured by Croda Oleochemicals), Stavinor (manufactured by Ceca), Acrawax and Glycolub (manufactured by Lonza Benelux B.V.), Ligalub (manufactured by Peter Greven Fettchemie), Realub (manufactured by Reagens Societa per Azioni Industria), Waxso (manufactured by SO.G.J.S. Industria Chimica S. p. a.), Unislip and Uniwax (manufactured by Uniqema) and Marklube (manufactured by Witco Vinyl Additives GmbH).

Metal soaps, especially the soaps of alkaline earth metals, are also suitable for use as lubricants in the resins of the present disclosure. These lubricants are known to stabilize plastics and also act as release agents. Suitable lubricants include those sold under trade names Ham Chem (manufactured by Akros Chemical), Baerolub (manufactured by Baerlocher GmBH), Lstab (manufactured by Chemson Polymer-Additive Ges.mbH), Licowax (manufactured by Clariant GmbH), Loxiol (manufactured by Cognis Deutchland GmbH), Lubriol (manufactured by Comiel (Morton International Group)), stavinor (manufactured by Ceca), Glycolub, Glycosperse, Lonzest and Pegosperse (manufactured by Lonza Benelux B.V.), Radiastar (manufactured by Fina Chemicals N.V.), Ligalub (manufactured by Peter Greven Fettchemie), Realub (manufactured by Reagens Societa per Azioni Industria) and Waxso (manufactured by SO.G.J.S. Industria Chimica S. p. a.).

An important group of lubricants is the montan waxes. Crude montan wax is a by-product of some, but not all, lignites. The chemistry of montan wax is comparable to the chemistry of fatty acids. Esters of long-chain alcohols, esters of mono- and polyfunctional short-chain alcohols and oligomeric (complex) esters are synthesized from montan wax acid. In addition, saponified products and several metal soaps also find applications as lubricants. Montan waxes are known to act as release agents and reduce viscosity. Suitable lubricants include those sold under trade names Interlite (manufactured by Akros Chemical), Luwax (manufactured by BASF AG), Licowax (manufactured by Clariant GmbH), and Stavinor (manufactured by Ceca).

Polar PE and PP waxes are also examples of suitable lubricants to be used in the resins of the present disclosure. Polar PE waxes are typically produced by introducing oxygen-containing polar groups into hydrocarbon by oxidation in air. Polar PP waxes are typically produced by grafting with maleic anhydride. Suitable lubricants include those sold under trade names Interlite (manufactured by Akros Chemical), Baerolub (manufactured by Baerlocher GmBH), Luwax (manufactured by BASF AG), Naftolub (manufactured by Chemson Polymer-Additive Ges.mbH), Licowax (manufactured by Clariant GmbH), Loxiol (manufactured by Cognis Deutchland GmbH), Vestowax (manufactured by Creanova), Epolene (manufactured by Eastman Chemicals International AG), Petrac waxes (manufactured by Ferro Carporation), A-C Polyethylene, AClyn lonomers and Acumist (manufactured by Honeywell), LE-Wachs (manufactured by Leuna Polymer GmbH) and Marklube (manufactured by Witco Vinyl Additives GmbH).

Fluoropolymers, i.e. polytetrafluoroethylene or oligomers having the general structure —(F2C—CF2)n-, are yet another example of suitable lubricants to be used in the resin of the present disclosure. Fluoropolymers improve the frictional properties. Suitable lubricants include those sold under trade name Dyneon PTFE Mikropulver (manufactured by Dyneon GmbH).

Yet other suitable examples of lubricants include silicone-based lubricants, i.e. polysiloxanes. These lubricants are based on molecules with the general structure (—R2Si—O—SiR2)n-, where R denotes an organic group, typically methyl or phenyl or a mixture thereof, and n represents the number of repeat units. It is known that silicone-based lubricants, and in particular polydimethylsiloxane (PDMS) improves mold filling, surface appearance, mold release, surface lubricity and wear resistance. Suitable lubricants include those sold under trade names Tegopren (manufactured by Th. Goldsmith AG) and Genioplast (manufactured by Wacker Chemical Corporation).

Specific examples of commercially available lubricants which are suitable for use in the resins of the present disclosure include, but are not limited to, Crodamide ER, Crodamide VRX, Crodamid OR, Crodamid ORX, Crodamid 212, Crodamid EBS, and Crodamid EBSV (manufactured by Croda), IncroMold K, IncroMold T (manufactured by Croda) and IncroMax PET 100 (manufactured by Croda), GENIOPLAST® PELLET P PLUS, GENIOPLAST® PELLET S, GENIOPLAST® FLUID 110 and GENIOPLAST® PELLET 345 (manufactured by Wacker Chemical Corporation), Kemamide E-180 (stearyl erucamide), Kemamide® P-181 (oleyl palmitamide) and Kemamide W-20 (manufactured by PMC Biogenix Inc).

In some embodiments the total amount of lubricants in the polyester resin is 0.1-5% (wt/wt) based on the total weight of the resin. In some embodiments the total amount of lubricants is 0.2-5% (wt/wt), such as 0.5-4% (wt/wt) more preferred 1-3.5% (wt/wt), even more preferred 2-3% (wt/wt) based on the total weight of the resin.

The resin may in addition to fillers, impact modifiers and lubricants also comprise other additives, such as nucleating agents, anti-hydrolysis additives, release agent, UV stabilizers, flame retardants, chain extenders, processing stabilizers, antioxidants and colouring agents or pigments.

The inventors of the present disclosure have also surprisingly found that in some cases beneficial effects are obtained when using non-reactive impact modifiers alone without the presence of reactive impact modifiers.

Hence, in alternative embodiments, the present disclosure relates to a toy building element made of a polyester material and manufactured by processing of a resin comprising at least one polyester and at least one non-reactive impact modifier, wherein the polyester is a poly(ethylene terephthalate) polyester (PET polyester) or a modified PET polyester, which has been modified by replacing
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; and/or
all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
   with the proviso that not all of the terephthalic acid groups and all of the ethylene glycol groups can be replaced at the same time, and with the proviso that the resin does not contain any reactive impact modifier.

The inventors of the present disclosure has surprisingly found that better flow properties can be obtained when using only non-reactive impact modifiers as compared with the use of a combination of reactive and non-reactive impact modifiers. It has also proven to be easier to control the compounding of non-reactive impact modifiers instead of carrying out a reactive compounding process with reactive impact modifiers.

The present disclosure is also directed to a method for the manufacture of a toy building element comprising the steps of
a) providing a resin comprising at least one polyester, at least one reactive impact modifier and at least one non-reactive impact modifier, wherein the polyester is a PET polyester or a modified PET polyester, which has been modified by replacing
   all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; and/or
   all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
with the proviso that not all of the terephthalic acid groups and all of the ethylene glycol groups can be replaced at the same time, and
b) processing said resin.

Suitable resins to be provided and processed in the method include those described above. Suitable examples of PET polyesters, modified PET polyesters, reactive impact modifiers and non-reactive impact modifiers include those mentioned above.

The total amount of impact modifiers is typically up to 25% (w/w) based on the total weight of the resin. In some embodiments the total amount of impact modifiers is 2-15% (wt/wt), such as 2-5% (wt/wt) or 5-8% (wt/wt) or 8-12% (wt/wt) based on the total weight of the resin. In some embodiments the amount of reactive impact modifier is in the range of 0.25-10% (wt/wt) based on total weight of resin. In other embodiments the total amount of non-reactive impact modifier is in the range of 0.25-15% (wt/wt) based on total weight of resin.

In some embodiments the toy building element is manufactured by injection molding.

In some embodiments the impact modifiers are mixed with the polyester during feeding of the injection molding machine. In such embodiments the total amount of impact modifier is preferably at most 3% (wt/wt) based on the total weight of the resin so that suitable dispersion of the impact modifier in the resin is obtained.

In preferred embodiments at least the reactive impact modifier is mixed with the polyester during feeding of the injection molding machine. In such embodiments the amount of reactive impact modifier is preferably at most 3% (wt/wt) based on the total weight of the resin so that suitable dispersion of the reactive impact modifier in the resin is obtained. In other embodiments the amount of reactive impact modifier is at most 9% (wt/wt), for example at most 6% (wt/wt), based on the total weight of the resin.

In other embodiments the impact modifiers are mixed with the polyester prior to feeding the mixture to the injection molding machine. The mixing may be performed by dry mixing or by compounding.

In some embodiments the impact modifiers and the polyester are dry mixed prior to feeding of the injection molding machine. In such embodiments the total amount of impact modifiers is preferably at most 5% (w/w) based on the total weight of the resin so that suitable dispersion of the impact modifier in the resin is obtained.

In other embodiments the impact modifiers and the polyester are mixed by compounding prior to feeding it to the injection molding machine. In such cases the resin is brought to its melted state and then thoroughly mixed to ensure sufficient dispersion of the impact modifier in the polyester and then the mixture is cooled, transformed into pellets and the pellets are then fed to the injection molding machine.

In embodiments where the impact modifiers and the polyester are mixed by compounding, the total amount of impact modifiers is typically up to 25% (w/w) based on the total weight of the resin. In some embodiments the total amount of impact modifiers is 2-15% (wt/wt), such as 2-5% (wt/wt) or 5-8% (wt/wt) or 8-12% (wt/wt) based on the total weight of the resin.

In some embodiments the impact modifiers and the polyester are compounded by thoroughly mixing to ensure sufficient dispersion and then fed directly into the injection molding machine.

In other embodiments the polyester and the impact modifiers may be mixed into a masterbatch which is then mixed with the rest of the resin during feeding of the injection molding machine.

Additives, such as fillers, nucleating agents, anti-hydrolysis additives, release agents, lubricants, UV stabilizers, flame retardants, chain extenders processing stabilizers, antioxidants and colouring agents or pigments, may be added and mixed with the impact modifiers and the polyester either prior to or during feeding to the injection molding machine.

In some embodiments the toy building element is manufactured by additive manufacturing. Suitable examples of additive manufacturing techniques are those in which the toy building element is built by photopolymerization additive manufacturing or thermoplastic additive manufacturing, such as liquid-based additive manufacturing, toner-based additive manufacturing, powder-based additive manufacturing or granulate-based additive manufacturing.

### EXAMPLES

In the examples below it is described how a toy building brick is manufactured by injection molding. The manufactured bricks were subsequently tested by the “Charpy v-notch test”.

Charpy v-Notch Test

Molded plastic rods with dimensions of 6.0×4.0×50.0 mm³, B×W×H, and in the relevant material to be tested were cut according to ISO 179-1/1 eA with a notch cutter (ZNO, Zwick, Germany) with a notch tip diameter of 0.5 mm. The notched specimens were placed with v-notch opposite pendulum and tested in a pendulum impact machine (HOT, Zwick, Germany) according to the principles described in ISO 179-1:2010.

### Example 1. Modification of PET with Paraloid™ EXL-3691J and ELVALOY™ PTW

Post-consumer bottle grade PET with an IV of 0.80 dl/g was dried at 150 degrees C. to a moisture content of 50-100 ppm. Upon ambient cooling of the dried PET material to below 50 degrees C., the PET was dry blended with the impact modifiers Paraloid™ EXL-3691) (an unreactive impact modifier from Dow Chemical Company) and ELVA LOY™ PTW (a reactive random terpolymer of ethylene, butyl acrylate and glycidyl methacrylate (epoxide functional) from Dow/Dupont Chemical Company). The quantities of each impact modifier arc listed in the table below. Blends were processed via twin screw extrusion into pellets followed by injection molding into tensile and impact bars. The obtained impact bars were tested in the Charpy v-notch test, as described above. The results are shown in the table below.

| | Paraloid ™ | ELVALOY ™ | |
|---|---|---|---|
| | EXL-3691J % | PTW % | Charpy |
| | (wt/wt) of | (wt/wt) of | v-notch |
| Trial | total weight | total weight | (kJ/m2) |
| 1-1 | 0 | 0 | 4 |
| 1-2 | 0 | 2 | 12 |
| 1-3 | 0 | 4 | 15 |
| 1-4 | 0 | 8 | 46 |
| 1-5 | 5 | 4 | 65 |
| 1-6 | 10 | 2.5 | 86 |
| 1-7 | 5 | 6 | 73 |
| 1-8 | 5 | 0 | 8 |
| 1-9 | 10 | 0 | 21 |

The injection molding parameters were as follows:
Melt temperature: 295 degrees C.
Hot runner temperature: 300 degrees C.
Mold temperature: 20 degrees C.

The extrusion processing parameters were as follows:
Barrel temperature: 290 degrees C.
Melt temperature: 295-300 degrees C.

When comparing trials 1-3, 1-8 and 1-5 it is seen that a molded plastic rod made of a resin containing 4% (wt/wt) ELVALOY™ PTW as the only impact modifier has a Charpy v-notch value of 15 kJ/m2 and a resin containing 5% (wt/wt) Paraloid™ EXL-3691J as the only impact modifier has a Charpy v-notch value of 8 kJ/m2. Very surprisingly, the results show that a molded plastic rod made of a resin comprising both impact modifiers in the same quantities, i.e. 4% (wt/wt) ELVALOY™ PTW and 5% (wt/wt) Paraloid™ EXL-3691J has a Charpy v-notch value of 65 kJ/m2. In other words, the results show that a synergistic effect is obtained when combining the reactive impact modifier and the non-reactive impact modifier.

A similar synergistic effect is also seen when comparing trials 1-2, 1-9 and 1-6.

To sum up, the results clearly show that a synergistic effect on the Charpy v-notch values is obtained when combining a reactive impact modifier (ELVALOY™ PTW) with an unreactive impact modifier (Paraloid™ EXL-3691J).

### Example 2. Modification of PETG and PETT with Paraloid™ EXL-3330 and ELVALOY™ PTW

Two different types of co-polyesters were tested in compounding trials with different types of impact modifiers. One common type of co-polyester is SkyGreen™ KN100 from SK Chemicals, which is a poly(ethylene glycol-co-1,4-cyclohexanedimethanol terephthalate) (PETG). Another type of co-polyester is Eastman™ GMX201 Natural from Eastman, which is a poly (ethylene glycol-co-2,2,4,4-tetramethyl-1,3-cyclobutanediol terephthalate) (PETT). Samples of PETG and PETT were dried at 70 degrees C. to a moisture content of 50-100 ppm. Upon ambient cooling of the dried materials to below 50 degrees C., the material samples were dry blended with the impact modifiers Paraloid™ EXL-3330 (unreactive impact modifier from Dow Chemical Company) and ELVALOY™ PTW (which is a reactive random terpolymer of ethylene, butyl acrylate and glycidyl methacrylate (epoxide functional) from Dow/Dupont Chemical Company) according to the table below. Blends were processed via twin screw extrusion into pellets followed by injection molding into tensile and impact bars.

The obtained impact bars were tested in the Charpy v-notch test, as described above. The results are shown in the table below.

| | | Paraloid ™ | ELVALOY ™ | Charpy |
|---|---|---|---|---|
| | Co- | EXL-3330 | PTW | v-notch |
| Trial | polyester | in % (w/w) | in % (w/w) | (kJ/m2) |
| 2-1 | PETG | 0 | 0 | 9.4 |
| 2-2 | PETT | 0 | 0 | 4.5 |
| 2-3 | PETG | 0 | 2.5 | 11.0 |
| 2-4 | PETG | 5 | 0 | 12.9 |
| 2-5 | PETG | 5 | 2.5 | 21.6 |
| 2-6 | PETT | 0 | 2.5 | 7.5 |
| 2-7 | PETT | 5 | 0 | 7.6 |
| 2-8 | PETT | 5 | 2.5 | 106.4 |

The injection molding parameters were as follows:
Melt temperature: 290 degrees C.
Hot runner temperature: 295 degrees C.
Mold temperature: 30 degrees C.

The extrusion processing parameters were as follows:
Barrel temperature: 290 degrees C.
Melt temperature: 295-300 degrees C.

When comparing trials 2-1, 2-3, 2-4 and 2-5 it is seen that a molded plastic rod made of a resin containing PETG and no impact modifier has a sharpy v-notch value of 9.4 kJ/m2. When adding 2.5% (wt/wt) ELVALOY™ PTW as the only impact modifier the PETG-containing resin has a Charpy v-notch value of 11.0 kJ/m2 and when adding 5% (wt/wt) Paraloid™ EXL-3330 as the only impact modifier the PETG-containing resin has a Charpy v-notch value of 12.9 kJ/m2. Very surprisingly, the results show that a molded plastic rod made of a resin, which contains PETG and comprising both 2.5% (wt/wt) ELVALOY™ PTW and 5% (wt/wt) Paraloid™ EXL-3330 has a Charpy v-notch value of 21.6 kJ/m2. In other words, the results show that a synergistic effect is obtained when combining the reactive impact modifier and the non-reactive impact modifier.

When comparing trials 2-2, 2-6, 2-7 and 2-8 it is seen that a molded plastic rod made of a resin containing PETT and no impact modifier has a sharpy v-notch value of 4.5 kJ/m2. When adding 2.5% (wt/wt) ELVALOY™ PTW as the only impact modifier the PETT-containing resin has a Charpy v-notch value of 7.5 kJ/m2 and when adding 5% (wt/wt) Paraloid™ EXL-3330 as the only impact modifier the PETG-containing resin has a Charpy v-notch value of 7.6 kJ/m2. Very surprisingly, the results show that a molded plastic rod made of a resin, which contains PETG and comprising both 2.5% (wt/wt) ELVALOY™ PTW and 5% (wt/wt) Paraloid™ EXL-3330 has a Charpy v-notch value of 106.4 kJ/m2. In other words, the results show that a synergistic effect is obtained when combining the reactive impact modifier and the non-reactive impact modifier.

To sum up: The results clearly show that a marked synergistic effect on the Charpy v-notch values is obtained when mixing a PETG-containing resin or a PETT-containing resin with both a reactive impact modifier (ELVALOY™ PTW) and an unreactive impact modifier Paraloid™ EXL-3330.

What is claimed is:

1. A toy building element made of a polyester material and manufactured by processing of a resin comprising at least one polyester, at least one reactive impact modifier and at least one non-reactive impact modifier, wherein the polyester is a poly(ethylene terephthalate) polyester (PET polyester) or a modified PET polyester, which has been modified by replacing:
all or parts of terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; or
all or parts of ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof; or
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof and all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
with the proviso that not all of the terephthalic acid groups or all of the ethylene glycol groups can be replaced at the same time.

2. The toy building element according to claim 1, wherein the polyester is a PET polyester or a modified PET polyester, which has been modified by replacing all or parts of the terephthalic acid groups of the PET polyester with isophthalic acid.

3. The toy building element according to claim 1, wherein the polyester is a modified PET polyester, which has been modified by replacing all of the terephthalic acid groups of the PET polyester with furandicarboxylic acid groups.

4. The toy building element according to claim 1, wherein the polyester is a mixture of:
a PET polyester or a modified PET polyester, which has been modified by replacing all or parts of the terephthalic acid groups of the PET polyester with isophthalic acid, and
a modified PET polyester, which has been modified by replacing all of the terephthalic acid groups of the PET polyester with furandicarboxylic acid groups.

5. The toy building element according to claim 1, wherein the polyester is a modified PET polyester, which has been modified by replacing parts of the ethylene glycol groups of the PET polyester with 1,4-cyclohexanedimethanol.

6. The toy building block according to claim 1, wherein the amount of the PET polyester or the modified PET polyester is in the range of 75-95% (wt/wt) based on total weight of resin.

7. The toy building block according to claim 1, wherein the amount of the reactive impact modifier is in the range of 0.25-10% (wt/wt) based on total weight of the resin.

8. The toy building block according to claim 1, wherein the amount of the non-reactive impact modifier is in the range of 0.25-15% (wt/wt) based on total weight of the resin.

9. The toy building block according to claim 1, wherein the resin further comprises an additive selected from the group consisting of fillers, nucleating agents, anti-hydrolysis additives, release agent, lubricants, UV stabilizers, flame retardants, chain extenders, processing stabilizers, antioxidants and colouring agents and/or pigments and mixtures thereof.

10. A method for the manufacture of a toy building element comprising the steps of:
providing a resin comprising at least one polyester, at least one reactive impact modifier and at least one non-reactive impact modifier, wherein the polyester is a PET polyester or a modified PET polyester, which has been modified by replacing:
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof; or
all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof; or
all or parts of the terephthalic acid groups of the PET polyester with a diacid monomer selected from the group consisting of adipic acid, succinic acid, isophthalic acid, furandicarboxylic acid, phthalic acid, 4,4′-biphenyl dicarboxylic acid, 2,6-naphthalenedicarboxylic acid and mixtures thereof and all or parts of the ethylene glycol groups of the PET polyester with a diol monomer selected from the group consisting of isosorbide, 1,4-cyclohexanedimethanol, 2,2,4,4-tetramehyl-1,3-cyclobutanediol, diethylene glycol, 1,2-propanediol, neopentylene glycol, 1,3-propanediol, 1,4 butanediol and mixtures thereof,
with the proviso that not all of the terephthalic acid groups and all of the ethylene glycol groups can be replaced at the same time; and
processing said resin.

11. The method according to claim 10, wherein the toy building element is manufactured by injection moulding and/or additive manufacturing of the resin comprising at least one polyester, at least one reactive impact modifier and at least one non-reactive impact modifier.

12. The method according to claim 10, wherein the resin further comprises an additive selected from the group consisting of fillers, nucleating agents, anti-hydrolysis additives, release agent, lubricants, UV stabilizers, flame retardants, chain extenders, processing stabilizers, antioxidants and colouring agents and/or pigments and mixtures thereof.

13. The method according to claim 10, wherein the impacts modifiers are mixed with the polyester(s) during feeding of the injection moulding machine.

14. The method according to claim 10, wherein the impacts modifiers are mixed with the polyester(s) prior to feeding the mixture to the injection moulding machine.
